(19) United States
(12) Patent Application Publication
(10) Pub. No.: US 2024/0288140 A1
(43) Pub. Date: Aug. 29, 2024

(54) PIXELATED LIGHTING DEVICE EMPLOYING DIRECT REFLECTION

(71) Applicant: VALEO VISION, Bobigny (FR)

(72) Inventors: Blaise JARS, Bobigny (FR); Vincent HUET, Bobigny (FR)

(73) Assignee: VALEO VISION, Bobigny (FR)

(21) Appl. No.: 18/569,072

(22) PCT Filed: Jun. 27, 2022
(86) PCT No.: PCT/EP2022/067631

§ 371 Date: Dec. 11, 2023

(30) Foreign Application Priority Data
Jun. 28, 2021 (FR) FR2106934

(51) Int. Cl. F21S 41/33; F21S 41/148; F21S 41/40; F21S 41/663

(52) U.S. Cl. CPC F21S 41/336; F21S 41/148; F21S 41/40; F21S 41/663

(57) ABSTRACT

A lighting device able to produce a pixelated overall beam. The device includes at least two light sources, respectively associated with at least two reflectors placed beside one another horizontally. According to the invention, each reflector includes at least two lateral sectors at two distinct horizontal positions, and, for each lateral sector, an extreme zone of the lateral sector located toward the exterior of the reflector is shaped to produce a clear cutoff in an individual beam issuing from the reflector.

### TECHNICAL FIELD

The present invention belongs to field of vehicle lighting, in particular for automotive vehicles.

### BACKGROUND OF THE INVENTION

It in particular relates to a pixelated or matrix lighting device for a vehicle, able to be installed in a headlamp of said vehicle.

The present invention is particularly advantageous in the context of a pixelated lighting device employing direct reflection, where a reflector reflects light delivered by light sources out of the vehicle directly.

By pixelated lighting device what is meant is a lighting device comprising a plurality of lighting segments, or pixels, that may be independently controlled. Thus, at any given time, it is possible to deactivate certain pixels, in order either to produce patterns on the road, via contrast, or to avoid dazzling a target on the road in a direction corresponding to the deactivated pixel or pixels. Such a device is sometimes called a matrix beam (or MxB for short).

Space constraints in an automotive vehicle headlamp mean that the width of the pixels of such lighting devices is limited. Moreover, the high number of pixels in such lighting devices limits the width of each thereof, for a given device width.

A small pixel width in single-reflection devices occasions substantial horizontal spreading of the light beam delivered by each pixel, and unsharp beam edges. However, one of the advantages of matrix lighting devices is the ability to deactivate one or more pixels in order to create one or more dark tunnels in the overall light beam of the lighting device. Unsharp individual-pixel-beam edges degrade the quality of such tunnels, or even prevent a tunnel from being created as a result of the beams of the pixels adjacent to the deactivated pixel encroaching on the horizontal position of the deactivated pixel.

There is thus a need to improve the quality of an overall beam of a pixelated single-reflection lighting device.

### BRIEF SUMMARY OF THE INVENTION

The present invention improves the situation.

To this end, a first aspect of the invention relates to a lighting device able to produce a pixelated overall beam and comprising:
at least a first light source and a second light source;
at least a first reflector associated with the first light source and a second reflector associated with the second light source, the first and second reflectors being placed side by side in a horizontal direction.

At least one of the reflectors comprises at least two lateral sectors in two distinct horizontal positions, and, for each lateral sector, a lateral-sector end zone located toward the outside of the reflector is shaped to produce a sharp vertical cut-off in an individual beam delivered by said reflector.

By “shaped to”, what is meant, throughout the present patent application, is that the element in question allows the mentioned characteristic to be realized without it being necessary to add a complementary element. For example, in the aforementioned case, the end zone alone allows the vertical sharp cut-off to be produced in the light delivered by the light source, without the need for any complementary optical element, such as, for example, a projecting lens placed after said reflector in the direction of travel of the light rays, and projecting the light delivered by said end zone, the sharp cut-off then being generated solely because of the presence of this lens.

By “sharp cut-off” what is meant is any light-beam contrast gradient greater than a given threshold, for example a threshold of 0.13, in particular a threshold of 0.18, and preferably a threshold of 0.30. Alternatively, the sharp cut-off may be defined relatively. According to such a relative definition, the light-beam contrast gradient of the cut-off in question is greater than that of another cut-off of the lateral sector, in particular a central cut-off. Such another cut-off is said to be “blurry”.

For example, the following is calculated for any point on a horizontal segment lying either side of the cut-off the gradient of which it is desired to measure:

$$G ( α ) = log ( I ( α + 0.05 ° ) ) - log ( I ( α - 0.05 ° ) )$$

where α is the angle along the horizontal axis of said point on the traced segment and I is the intensity of the beam at the angle in question.

In practice, a sharp edge is produced by a shape of the reflector, which shape is located at the edge of the reflector and able to reflect light rays from the light source substantially parallel. Thus, the rays delivered by the end zone are substantially parallel, this allowing a vertical “sharp cut-off” or a vertical “sharp edge” to be produced. In contrast, a blurred light beam, or a blurred part of a light beam, is formed by light rays having a plurality of horizontal directions.

The horizontal direction is defined when the lighting device is placed in a normal direction of operation. In particular, the horizontal direction may be a direction different from the horizontal direction X of propagation of the light rays when the lighting device is placed in the normal position of operation. The horizontal direction may in particular be the horizontal Y direction, normal to X and to a vertical Z axis, in which the lighting device extends widthwise. The Y direction is also called the transverse direction below. The lighting device extends widthwise in the transverse Y direction.

Thus, reflector sectorization associated with shaping of the end zones to produce a sharp cut-off makes it possible to overcome the identified drawbacks of the prior art, and makes it possible to produce individual beams of pixels of better precision. It is thus made possible to form clearly delineated dark tunnels in the overall light beam of the single-reflection pixelated lighting device.

According to one embodiment, each lateral sector may comprise two zones including the end zone shaped to produce the vertical sharp cut-off in the individual beam and a central zone shaped to contribute to production of a central part of the individual beam.

The central zone thus makes it possible to contribute to the part of the individual light beam that generates the width of the pixel in the transverse Y direction and the maximum light intensity. A better individual-beam precision is thus obtained, not only in respect of edge sharpness, but also in respect of the other characteristics of the pixel, namely horizontal width and light intensity.

According to one embodiment, said at least one reflector may comprise at least one central sector, shaped to contribute to production of a central part of the individual beam.

A sector dedicated to the central part of the beam allows the precision of the individual beam of the pixel to be improved, in particular as regards horizontal width in the transverse Y direction and light intensity. The central sector may in particular combine with the central zones of the end sectors to produce the central part of the individual beam.

According to one embodiment, the reflector may be shaped in such a way that the individual beam delivered by the reflector has a horizontal angular width comprised between 8° and 14°.

Such an angular width for each reflector makes it possible to obtain a wide overall beam with a low number of pixels.

According to one embodiment, the first reflector may be shaped and positioned to reflect the light rays of the first light source into a first individual beam and the second reflector may be shaped and positioned to reflect the light rays delivered by the second light source into a second individual beam, and the first and second individual beams may have a horizontal angular superposition comprised between 3° and 8°.

Such a superposition makes it possible to ensure the uniformity of the overall beam while allowing dark tunnels to be created, since the range of superposition is limited.

According to one embodiment, the lighting device may further comprise an opaque screen or a mask, placed between the light sources and the reflectors, so as to prevent light rays delivered by the first light source from reaching the second reflector, and light rays delivered by the second light source from reaching the first reflector.

This embodiment makes it possible to ensure a better precision in the individual light beams.

According to one embodiment, each reflector may have a horizontal dimension, in a transverse Y direction, comprised between 25 and 45 mm.

Such a limited dimension has the advantage of decreasing the overall size associated with the lighting device, or making it possible to increase the number of pixels, while allowing advantage to be fully taken of the sectorization of the reflectors, which compensates for the drawbacks associated with a small reflector width.

According to one embodiment, the device may comprise between two and six reflectors and between two and six light sources respectively associated with the reflectors, the reflectors being placed in respective horizontal positions beside one another.

Such an embodiment allows a compromise between the fact of ensuring the lighting device is associated with a limited overall size and the fact of having enough pixels to allow various and configurable matrix light-emitting functions to be achieved.

In one embodiment, the light sources may be individually drivable, and the reflectors may be arranged in such a way that turning off a light source induces a dark tunnel in the pixelated overall beam.

It is thus made possible to create a dark tunnel the edges of which are sharp.

A second aspect of the invention relates to an automotive vehicle headlamp comprising a housing, an outer lens closing the housing and a lighting device according to the first aspect the invention placed in the volume located between the housing and the closing outer lens.

### BRIEF DESCRIPTION OF THE DRAWINGS

Other features and advantages of the invention will become apparent on examining the following detailed description and the appended drawings, in which:

FIG. 1 illustrates a lighting device according to one embodiment of the invention;

FIG. 2 illustrates a horizontal cross-sectional view of a reflector of a lighting device according to one embodiment of the invention;

FIG. 3 illustrates parts of the individual beam delivered by a reflector of a lighting device according to one embodiment of the invention;

FIG. 4 illustrates an individual beam delivered by a reflector of a lighting device according to one embodiment of the invention; and

FIG. 5 illustrates a pixelated overall beam delivered by a lighting device according to one embodiment of the invention.

### DETAILED DESCRIPTION OF THE INVENTION

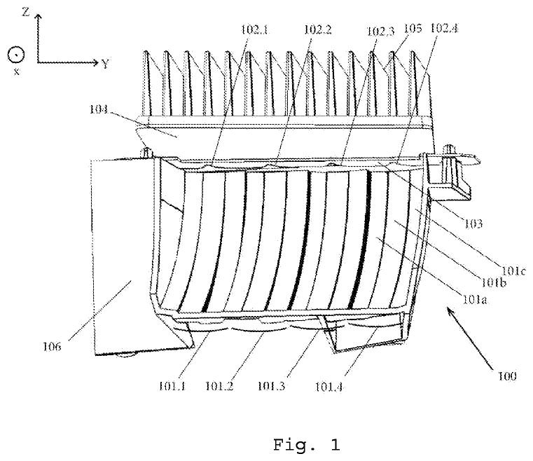

FIG. 1 shows a lighting device 100 according to one embodiment of the invention.

FIG. 1 shows the lighting device 100 as seen from in front in a Y-Z plane by an observer located outside the vehicle, on the path of certain of the light rays the direction of travel of which is mainly along the X axis. The X direction is therefore defined by the overall direction of the light beam emitted by the lighting device 100.

The lighting device 100 according to the invention is a direct-reflection, or single-reflection, device, i.e. the light rays delivered by a source 102.i, i being an integer comprised between 1 and 4, are reflected directly out of the vehicle (in the X direction) by reflection from a reflector 101.i.

Below, the expression “source 102” designates any of the sources 102.i, and likewise the expression “reflector 101” designates any of the reflectors 101.i.

The lighting device 100 according to the invention is preferably a matrix device, with a plurality of pixels, each formed by one light source 102 and one reflector 101. The lighting device 100 illustrated in FIG. 1 comprises four pixels, respectively comprising:
a first light source 102.1 associated with a first reflector 101.1;
a second light source 102.2 associated with a second reflector 101.2;
a third light source 102.3 associated with a third reflector 101.3;
a fourth light source 102.4 associated with a fourth reflector 101.4.

No limit is placed on the number of pixels of the light-emitting device 100, which may be any number greater than or equal to 2, and preferably less than 6 for reasons of space constraints associated with the lighting device 100. The pixels are distributed horizontally along the Y axis. Each reflector 101 has a given width along the Y axis, extends vertically along the Z axis and is curved along the X axis so as to reflect the light emitted by the light sources 102 along the Z axis, in a direction substantially parallel to the X axis.

No restrictions are placed on the technology employed for the light sources 102, the latter possibly being light-emitting diodes (LEDs for example) with at least one light-emitting element, or sources in any other light-emitting technology (laser technology, laser-matrix-array technology, xenon-lamp technology and halogen-lamp technology in particular). An LED has the advantage of a good light-beam quality, of a smaller overall size and of a low cost. In addition, the light sources 102.1 to 102.4 when they are LEDs may all be mounted on the same printed circuit board 104 or PCB. Below, the example of LED sources is considered, non-limitingly and merely for the sake of simplicity. The PCB 104 may be mounted on a heatsink 105 allowing the temperature of the light sources 102 to be regulated, by dissipating heat, thus improving their operation and increasing their lifespan.

The pixelated overall beam delivered by the lighting device 100 is obtained by combining the individual beams delivered by each of the pixels.

However, such a matrix device allows the light sources to be activated independently. It is thus possible to deactivate certain of the light sources in order to create a light “tunnel” in the overall beam, the tunnel extending horizontally along the Y axis. Such a tunnel makes it possible to avoid dazzling certain targets located in a horizontal position corresponding to that of the deactivated pixel, or makes it possible to trace a luminous pattern on the road via a contrast effect.

According to the invention, each of the reflectors 101 comprises at least two lateral sectors 101a and 101c. Optionally, each reflector 101 may further comprise a central sector 101b. According to another variant, not shown in FIG. 1, each reflector 101, or at least one of the reflectors 101, may comprise two central sectors, i.e. four sectors in all. Thus, a reflector 101 according to the invention comprises between two and four sectors. As shown in FIG. 1, the sectors of a reflector 101 occupy distinct horizontal positions, along the Y axis, and are placed side by side.

According to the invention, for each lateral sector 101a and 101c, a lateral-sector end zone located toward the outside of the reflector 101 is shaped to produce a sharp vertical cut-off in an individual beam delivered by the reflector 101. Thus, the left-hand lateral sector 101a is shaped to produce a sharp cut-off on the left of the individual beam of the reflector 101 and the right-hand lateral sector 101c is shaped to produce a sharp cut-off on the right of the individual beam of the reflector 101. By “sharp cut-off” what is meant is any light-beam contrast gradient greater than a given threshold, for example a threshold of 0.13, in particular a threshold of 0.18, and preferably a threshold of 0.30. Alternatively, the sharp cut-off may be defined relatively. According to such a relative definition, the light-beam contrast gradient of the cut-off in question is greater than that of another cut-off of the lateral sector, in particular a central cut-off. Such another cut-off is said to be “blurry”.

For example, the following is calculated for any point on a horizontal segment lying either side of the cut-off the gradient of which it is desired to measure:

$$G ( α ) = log ( I ( α + 0.05 ° ) ) - log ( I ( α - 0.05 ° ) )$$

where α is the angle along the horizontal axis of said point on the traced segment and I is the intensity of the beam at the angle in question.

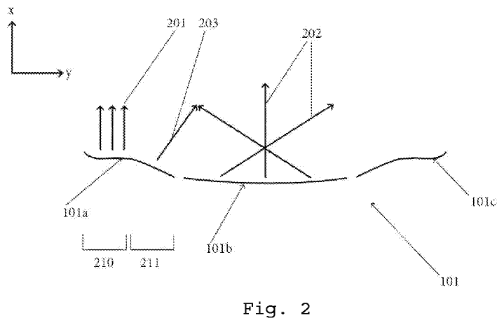

In practice, a sharp edge is produced by a shape of the reflector, which shape is located at the edge of the reflector and able to reflect light rays from the light source 102 substantially parallel to one another. Thus, the rays delivered by the end zone are substantially parallel, this allowing a “sharp cut-off” or a “sharp edge” to be produced. In contrast, a blurred light beam, or a blurred part of a light beam, is formed by light rays having a plurality of directions. These principles will be better understood in the light of the description of FIG. 2.

Sectorization of a reflector 101 according to the invention advantageously makes it possible to obtain pixels with reflectors of small width with sharp luminous edges, thus improving the precision of the matrix of pixels, while allowing a plurality of pixels to be placed horizontally.

Preferably, the horizontal angular width of an individual beam may be comprised between 8 and 14°. Such values make it possible both to obtain an overall beam of sufficient width, while allowing tunnels to be created by deactivating one or more of the sources 102.

Preferably, the width along the Y axis of each reflector 101 is comprised between 25 and 45 mm. Specifically, a small reflector width requires the light source to be very close and causes the individual beams to spread greatly along the Y axis, leading to an increased need to make the edges of the beam sharper. With reflectors other than those of the invention, in such width ranges, the edges of the individual beams would be very spread out, and therefore blurred or not very sharp. With such a width, it is preferable for the number of pixels to be less than or equal to 6, in order to limit the overall size associated with the lighting device 100 and to facilitate its installation in an automotive vehicle headlamp.

Obtaining sharp edges for each individual beam delivered by a reflector 101 of the light-emitting device 100 further makes it possible to deliver a precise zone of overlap between each pixel. Such a zone of overlap makes it possible to obtain a uniform overall beam, in which the individual beam corresponding to a given pixel cannot be discerned. However, the overlap must not be too great, as otherwise there is a risk that horizontal tunnels will not be able to be created by deactivating a light source 101. To this end, the horizontal width of the zone of overlap between two adjacent individual beams may be comprised between 3° and 8°.

The lighting device 100 according to the invention may further comprise one or more opaque screens or masks 103. The opaque screen or mask 103 is shaped and placed to prevent a light source 102 from illuminating the reflective surface of a reflector 101 with which it is not associated, such as an adjacent reflector. By way of example, the screen 103 prevents the light rays delivered by the second source 102.2 from reaching the reflective surfaces of the first reflector 101.1 and of the third reflector 101.3. A single-piece opaque screen or mask 103 is shown in FIG. 1 merely by way of illustration. As a variant, an individual screen may be provided for each light source 102.

The screen 103 thus makes it possible to improve the quality of the individual beam of each pixel, and consequently improves the overall beam.

The lighting device 100 may be linked to a housing 106 of an automotive vehicle headlamp, further comprising a closing outer lens.

Advantageously, the elements of the lighting device 100 may be fastened to one another by fastening means (not shown in FIG. 1) or may be individually fastened to the housing 106.

FIG. 2 illustrates a horizontal cross-sectional view of a reflector 101 of a lighting device 100 according to one embodiment of the invention.

The reflector 101 shown in FIG. 2 comprises three sectors 101a, 101b and 101c. However, as explained above, the reflector 101 according to the invention comprises at least the two lateral sectors 101a and 101c, and may further comprise the central sector 101b or two central sectors 101b.

The lateral sectors 101a and 101c may advantageously comprise an end zone 210 located toward the outside of the reflector 101 along the horizontal Y axis, and a central zone 211 located toward the center of the reflector 101 along the horizontal Y axis.

The end zone 210 is shaped to produce the sharp cut-off in the individual beam, while the central zone 211 is shaped to contribute to production of a dispersed central part of the individual beam.

Specifically:
the end zone 210 is shaped to reflect light rays 201 delivered by the light source 102 in a direction substantially parallel to the main direction of the light beam delivered by the lighting device, in the present case a direction substantially parallel to the X axis;
the central zone 211 is shaped to reflect light rays 203 delivered by the light source 102 in a direction different from the direction of the rays 201, in order to combine with rays 202 delivered by the central sector 101b to form the spread central part of the individual light beam of the reflector 101. The central zone 211 is however optional in that the lateral sector may comprise only the end zone producing the sharp cut-off, provided that the lighting device comprises a central sector allowing the sharp edges of the lateral sectors to be recombined. In particular, removal of the central part is advantageous for pixels of small width and when the reflector is large in size.

No restrictions are placed on the shape of the horizontal cross section of the lateral sectors 101a and 101c. By way of illustration, such a shape may undulate and have an inflection point separating the end zone 210 from the central zone 211.

As indicated in FIG. 2, the central sector 101b is shaped to contribute to production of a blurred central part of the individual beam, since the reflected rays 202 are scattered and have a broad spectrum of different directions.

Thus, when the reflector 101 does not comprise a central segment 101b, the spread central part of the individual beam is formed by the central zones 211 of the lateral segments 101a and 101c.

No restrictions are placed on the shape of the horizontal cross section of the central sector 101b. By way of illustration, the central sector 101b may have the concave shape illustrated in FIG. 2.

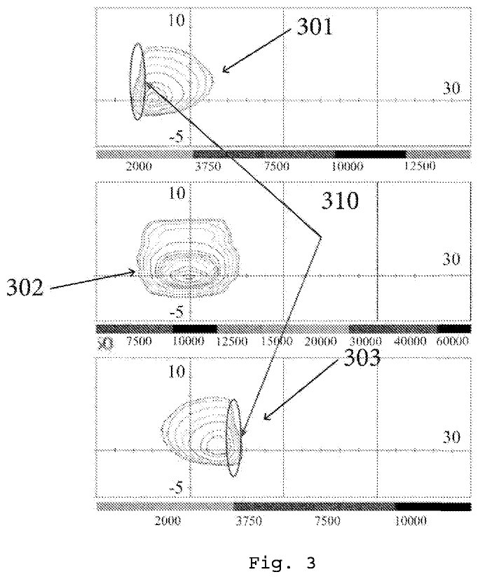

FIG. 3 illustrates parts of the individual beam delivered by a reflector of a lighting device according to one embodiment of the invention.

Part 301 corresponds to the light rays delivered by the left-hand lateral sector 101a of the reflector 101, and thus comprises a sharp edge 310 produced by the end zone 210 and a blurred part produced by the central part 211.

Part 302 corresponds to the light rays delivered by the central sector 101b of the reflector 101, and thus comprises scattered light rays 202 that spread over almost the entire width of the individual beam of the reflector 101.

Part 303 corresponds to the light rays delivered by the right-hand lateral sector 101c of the reflector, and thus comprises a sharp edge 310 produced by an end zone and a blurred part produced by a central part.

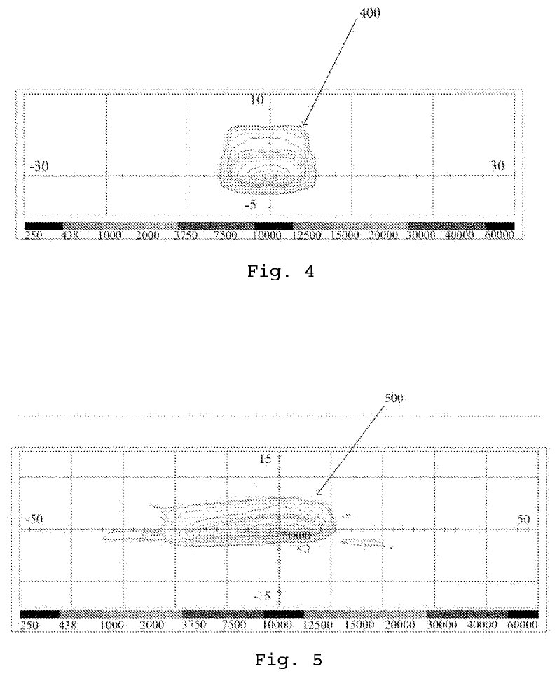

FIG. 4 illustrates an individual beam 400 delivered by a reflector of a lighting device according to one embodiment of the invention.

The individual beam 400 of the reflector 101 is obtained by combining the parts 301, 302 and 303 illustrated with reference to FIG. 3.

The individual beam 400 thus comprises sharp right and left edges obtained from the parts 301 and 303 described above. As regards the blurred central part, it is obtained from the central zones 211 of the lateral sectors 101a and 101c and from the central sector 101b.

FIG. 5 illustrates a pixelated overall beam delivered by a lighting device according to one embodiment of the invention.

The pixelated overall beam 500 is obtained from the individual beams 400 delivered by the various reflectors 101.1 to 101.4 of the lighting device 100.

Because of the superposition of the individual beams, the pixelated overall beam 500 is uniform and does not allow its various constituent pixels to be discerned.

The present invention is not limited to the embodiments described above by way of example; it covers other variants.

What is claimed is:

1. A lighting device able to produce a pixelated overall beam, comprising:
at least a first light source and a second light source;
at least a first reflector associated with the first light source and a second reflector associated with the second light source, the first and second reflectors being placed side by side in a horizontal direction;
wherein at least one of the reflectors includes at least two lateral sectors in two distinct horizontal positions, and wherein, for each lateral sector, a lateral-sector end zone located toward the outside of the reflector is shaped to produce a sharp vertical cut-off in an individual beam delivered by the reflector.

2. The device as claimed in claim 1, wherein each lateral sector includes two zones including the end zone shaped to produce the vertical sharp cut-off in the individual beam and a central zone shaped to contribute to production of a central part of the individual beam.

3. The device as claimed in claim 1, wherein the at least one reflector includes at least one central sector, shaped to contribute to production of a central part of the individual beam.

4. The device as claimed in claim 1, wherein the reflector is shaped in such a way that the individual beam delivered by the reflector has a horizontal angular width comprised between 8 and 14°.

5. The device as claimed in claim 1, wherein the first reflector is shaped and positioned to reflect the light rays of the first light source into a first individual beam and the second reflector is shaped and positioned to reflect the light rays delivered by the second light source into a second individual beam, and wherein the first and second individual beams have a horizontal angular superposition comprised between 3° and 8°.

6. The device as claimed in claim 1, further comprising an opaque screen or mask placed between the light sources and the reflectors, so as to prevent light rays delivered by the first light source from reaching the second reflector, and light rays delivered by the second light source from reaching the first reflector.

7. The device as claimed in claim 1, wherein each reflector has a horizontal dimension, in a transverse direction Y, comprised between 25 and 45 mm.

8. The device as claimed in claim 1, includes between two and six reflectors and between two and six light sources respectively associated with the reflectors, the reflectors being placed in respective horizontal positions beside one another.

9. The device as claimed in claim 1, wherein the light sources are individually drivable, and wherein the reflectors are arranged in such a way that turning off a light source induces a dark tunnel in the pixelated overall beam.

10. An automotive vehicle headlamp comprising a housing, an outer lens closing the housing and a lighting device placed in the volume located between the housing and the closing outer lens, with the lighting device including at least a first light source and a second light source, at least a first reflector associated with the first light source and a second reflector associated with the second light source, the first and second reflectors being placed side by side in a horizontal direction, wherein at least one of the reflectors includes at least two lateral sectors in two distinct horizontal positions, and wherein, for each lateral sector, a lateral-sector end zone located toward the outside of the reflector is shaped to produce a sharp vertical cut-off in an individual beam delivered by the reflector.
